(19) United States
(12) Patent Application Publication
(10) Pub. No.: US 2023/0297048 A1
(43) Pub. Date: Sep. 21, 2023

(54) ELECTRICAL POWER SYSTEMS AND METHODS

(71) Applicant: Schneider Electric USA, Inc., Andover, MA (US)

(72) Inventor: Brett Larson, Cedar Rapids, IA (US)

(73) Assignee: Schneider Electric USA, Inc., Boston, MA (US)

(21) Appl. No.: 17/696,581

(22) Filed: Mar. 16, 2022

(51) Int. Cl. G05B 19/042

(52) U.S. Cl. CPC G05B 19/042; G05B 2219/2639

(57) ABSTRACT

An electrical power system can include a load fault module configured to determine a faulty load of a plurality of loads on an electrical circuit by using load information and/or load power data to output a faulty load indication and/or load control.

### FIELD

This disclosure relates to electrical power systems and methods.

### BACKGROUND

In traditional circuit breaker systems, finding the cause of a trip is not easy as the fault can be caused anywhere in the circuit downstream of the circuit breaker. The only way to find a fault is to manually test all loads and connections iteratively.

Such conventional methods and systems have generally been considered satisfactory for their intended purpose. However, there is still a need in the art for improved electrical power systems and methods. The present disclosure provides a solution for this need.

### SUMMARY

In accordance with at least one aspect of this disclosure, an electrical power system can include a load fault module configured to determine a faulty load of a plurality of loads on an electrical circuit by using load information and/or load power data to output a faulty load indication and/or load control.

The load fault module can be configured to be in operative communication with a circuit breaker, and to receive a fault indication from the circuit breaker to initiate determination of the faulty load. The load fault module can be configured to be in operative communication with one or more controllable loads of the plurality of loads to control the one or more controllable loads of the plurality of loads to determine the faulty load.

The load fault module can be configured to successively shut down and/or turn on each controllable load while maintaining power from the circuit breaker to monitor whether a fault is eliminated after each shut down and/or turn on to isolate the faulty load in the plurality of loads. The load fault module can be configured such that if the fault is eliminated after shut down and/or seen after turn on of a controllable load, that controllable load is determined to be the faulty load or associated in a branch of the circuit with the faulty load. The load fault module can be configured to use machine learning to diagnose the plurality of loads to determine the faulty load.

In certain embodiments, the load fault module is configured to output load power cycle instructions to a user interface module for a user to manually power off and/or power on one or more loads of the plurality of loads while maintaining power from the circuit breaker to monitor whether a fault is eliminated after each shut down and/or turn on to isolate the faulty load in the plurality of loads. Any suitable instructions are contemplated herein.

The system can include a circuit breaker configured to connect to the electrical circuit to selectively connect and disconnect power supply to the electrical circuit. The circuit breaker can be an advanced function breaker configured to output parameters of operation. For example, the circuit breaker can be a wireless circuit breaker configured to be remotely controlled.

In certain embodiments, the load fault module is included in the circuit breaker. In certain embodiments, the circuit breaker is configured to communicate with a hub system, wherein the hub system is configured to communicate with a user device to allow control of the circuit breaker.

In accordance with at least one aspect of this disclosure, a computer implemented method can include monitoring a circuit, detecting a fault, and determining a faulty load of a plurality of loads on the circuit by correlating a state of one or more loads of the plurality of loads to an effect on the circuit. The method can include successively controlling one or more controllable loads of the plurality of loads on a circuit to determine the effect of the one or more controllable loads on the circuit. Successively controlling each controllable load can include successively shutting down and/or turning on each controllable load.

Monitoring the circuit can include monitoring for elimination of the fault after shutting down and/or turning on each load to determine which controllable load caused the fault. The method can include outputting a fault indication that indicates which load is a faulty load to a user interface. In certain embodiments, monitoring a circuit can include receiving operational parameters from an advanced function circuit breaker.

In certain embodiments, the method can further include shutting down the circuit breaker and turning off all loads, turning the circuit breaker on and maintaining the circuit breaker in the on state while the faulty load is determined by iteratively powering on each load until a fault or indicator of a fault is seen. In certain embodiments, the method can include outputting instructions to a user interface for a user to successively control one or more loads of the plurality of loads on a circuit to determine the effect of the one or more loads on the circuit. The method can include any other suitable method(s) and/or portion(s) thereof.

In accordance with at least one aspect of this disclosure, a non-transitory computer readable medium can have computer executable instructions configured to cause a computer to perform a method. The method can include monitoring a circuit, detecting a fault, and determining a faulty load of a plurality of loads on the circuit by correlating a state of one or more loads of the plurality of loads to an effect on the circuit. The method can include any other suitable method(s) and/or portion(s) thereof (e.g., as described above).

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic diagram of an electrical system in accordance with this disclosure, shown connected to a circuit; and

FIG. 2 is a flow diagram of an embodiment of a method in accordance with this disclosure.

### DETAILED DESCRIPTION

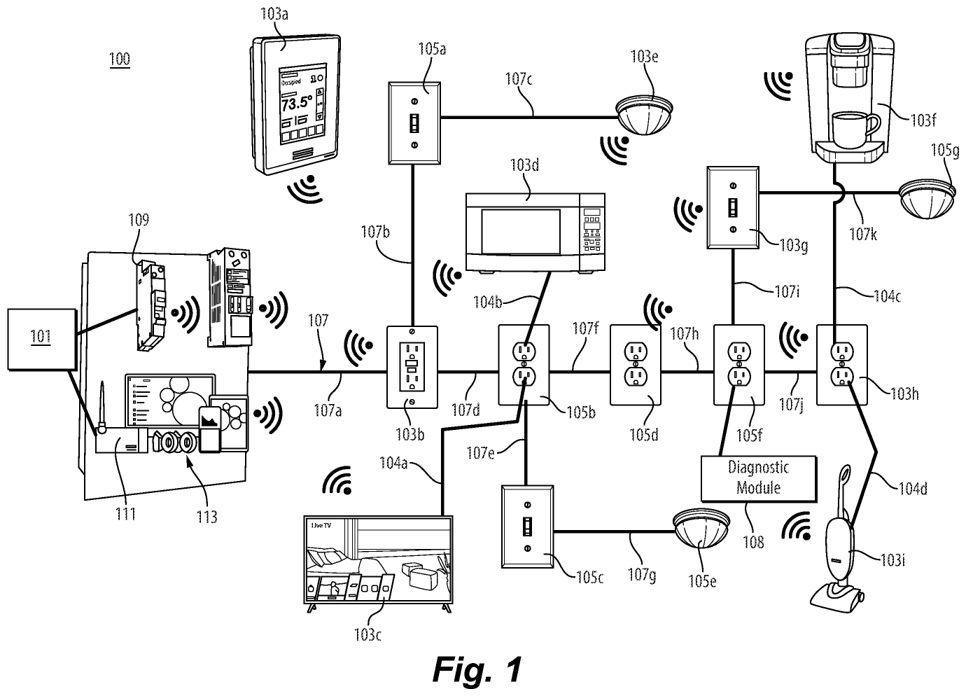

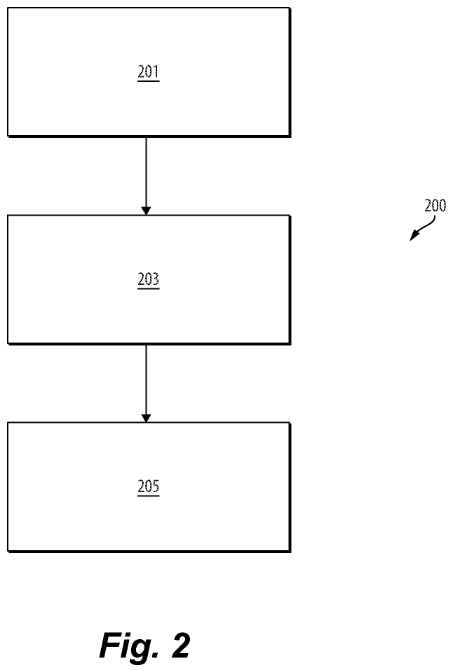

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIG. 2. Certain embodiments described herein can be used to determine which load in a plurality of loads on a circuit (e.g., a single circuit) is causing an electrical fault.

In accordance with at least one aspect of this disclosure, referring to FIG. 1, an electrical power system 100 can include a load fault module 101 configured to determine a faulty load of a plurality of loads 103a, b, c, d, e, f, g, h, i, 104a, b, c, d 105a, b, c, d, e, f, g, 107a, b, c, d, e, f, g, h, i, j, k on an electrical circuit 107 by using load information (e.g., status data from a load) and/or load power data (e.g., whether a load is powered or unpowered, or switching between powered and unpowered) to output a faulty load indication (e.g., a warning message to a user interface) and/or load control (e.g., a control signal to control a load or associated device). The load fault module 101 can include any suitable hardware and/or software module(s) configured to perform any suitable function (e.g., as disclosed herein, e.g., as described above). As used herein, the term “load” includes ultimate loads (e.g., lights 103e, 105e, 105g and appliances 103a, 103c, 103d, 103f, 103i), circuit devices (e.g., switches 103g, 105a, 105c, outlets 103b, 103h, 105b, 105d, 105f), and connections (e.g., branch circuit wiring 107a, 107b, 107c, 107d, 107e, 107f, 107g, 107h, 107i, 107j, 107k of circuit 107 and cord sets 104a, 104b, 104c, 104d) connecting the loads to the circuit 107.

The load fault module 101 can be configured to be in operative communication with a circuit breaker 109 (e.g., of the circuit 107), and to receive a fault indication from the circuit breaker 109 (e.g., that the circuit breaker 109 is about to trip) to initiate determination of the faulty load. In certain embodiments, the load fault module 101 can be configured to be in operative communication with one or more controllable loads 103a, b, c, d, e, f, g, h, i of the plurality of loads 103a-i, 104a-d, 105a-h to control the one or more controllable loads 103a-i of the plurality of loads 103a-i, 104a-d, 105a-h to determine the faulty load.

In certain embodiments, the load fault module 101 can be configured to successively shut down and/or turn on each controllable load 103a-i while maintaining power from the circuit breaker 109 to monitor whether a fault is eliminated after each shut down and/or turn on to isolate the faulty load in the plurality of loads 103a-i, 104a-d, 105a-h. In certain embodiments, fault monitoring could be in aggregate of all the circuits originating from a loadcenter. Therefore the load fault module can also be configured for turning off and on the circuit breaker to locate the fault location within the distribution system. The load fault module 101 can be configured such that if the fault is eliminated after shut down and/or seen after turn on of a controllable load 103a-i, that controllable load is determined to be the faulty load or associated in a branch of the circuit 107 with the faulty load.

For example, if the light 105g is faulty, when the light 105g is turned on, a fault would be seen at the circuit breaker 109. The load fault module 101 can then begin iteratively cycling each controllable device 103a-i. The load fault module 101 would eventually shut down controllable switch 103g, and the fault seen at the circuit breaker 109 would disappear. The load fault module 101 can then determine that the fault is either the switch 103g or the light 105g or the branch circuit wiring 107a, 107d, 107f, 107h, 107i, 107k to or in between the two devices). In certain embodiments, the load fault module 103g can know what the loads 103g and 105g are and determine based on operational characteristic (e.g., signal effects at the circuit breaker 109) which of the two loads 103g, 105g is the faulty load, and/or if there is a fault in the branch circuit wiring 107a, 107d, 107f, 107h, 107i, 107k.

In certain embodiments, the faulty load may be a controllable load (e.g., 103a, 103c, 103d, 103f, 103i) that has no downstream components. In this case, the load fault module 101 can conclusively determine that such a load is a faulty load when shutting down and/or powering on.

In certain embodiments, the load fault module 101 can be configured to use machine learning to diagnose the plurality of loads 103a-i, 104a-d, 105a-h to determine the faulty load. Any other suitable logic is contemplated herein.

In certain embodiments, the load fault module 101 can be configured to output load power cycle instructions to a user interface module 111 for a user to manually power off and/or power on one or more loads (e.g., manual switch 105c with light 105e downstream thereof) of the plurality of loads 103a-i, 104a-d, 105a-h while maintaining power from the circuit breaker 109 to monitor whether a fault is eliminated after each shut down and/or turn on to isolate the faulty load in the plurality of loads 103a-i, 104a-d, 105a-h. In certain embodiments, a system may have no controllable loads and a user may be instructed to iteratively power cycle each component connected to the circuit 107. Any suitable instructions are contemplated herein.

In certain embodiments, the system 100 can include a circuit breaker 109 configured to connect to the electrical circuit 107 to selectively connect and disconnect power supply to the electrical circuit 107. In certain embodiments, the circuit breaker 109 can be an advanced function breaker (e.g., as shown) that is configured to output parameters of operation (e.g., signal quality data such as current, frequency, etc.). For example, the circuit breaker 109 can be a wireless circuit breaker configured to be remotely controlled. Embodiments of a circuit breaker 109 can be a non-advanced function circuit breaker, e.g., where the fault monitoring is done at an aggregate level by a system controller and current transformers (or other suitable current sensors) and there is manual instruction if the circuit breaker needs to be turned on or off. Any suitable circuit breaker type for any suitable system arrangement and logic disambiguation is contemplated herein.

In certain embodiments, the load fault module 101 can be included in the circuit breaker 109. In certain embodiments, the load fault module 101 can be a stand-alone device (e.g., in a portable diagnostic module 108 that can be plugged in to the circuit 107, e.g., at an outlet). In certain embodiments, the load fault module 101 can be a part of a control system for an electrical system. The load fault module 101 can exist in a single location and/or be federated components hosted on multiple devices that work together to comprise the load fault module 1010. Any suitable location and/or disambiguation of the load fault module 101 is contemplated herein. For example, fault detection can be done at a centralized control module, a circuit breaker, one or more smart switches or receptacles, one or more cord set modules, and/or one or more smart appliances/devices. System control logic can be hosted at the control module or it could be a distributed computational model with all connected smart device compromising the system.

Moreover, any suitable faulty load type is contemplated herein. For example, a faulty load can be or include an insulation failure (e.g., line to line or line to ground), current path failure (e.g., broken conductors, failed connectors, failed current carrying components), and/or device component failure (e.g., defective switches, motors, heaters, etc). A faulty load can be a device that intentionally or unintentionally draws more current than the overcurrent protective device or in combination with another device or fault draws more current that the overcurrent protective device. As a load as described herein can be anything that is part of the electrical distribution system, any suitable fault for any suitable type of load is contemplated herein.

In certain embodiments, the circuit breaker 109 can be configured to communicate with a hub system 113 (e.g., including user interface module 111). The hub system 113 can be configured to communicate with a user device (e.g., a mobile device, a computer, or any other suitable device, e.g., via an app) to allow control of the circuit breaker 109.

In certain embodiments, the load fault module 101 can be configured to determine if one or more devices are incompatible (e.g., in use together on the same circuit 107). For example, if an appliance 103f gives off only an arc frequency indicative of an arc fault, but not the associated current, and appliance 103i gives off only a current, but not an associated frequency that would cause tripping of the circuit breaker 109, then the load fault module 101 can identify the issue as a compatibility issue. The load fault module 101 can inform a user and/or overlook the issue, and/or instruct a user not to use the incompatible devices together. In certain embodiments, the load fault module 101 can be configured to determine whether a particular device is function properly based on stored manufacturer performance data and can notify a user if a particular device is causing an issue, for example. In certain embodiments, the load fault module 101 can be configured to control subcomponents of a device (e.g., pump of coffee machine, heater of coffee machine) and isolate what the subcomponent is that is faulting if a device is configured to provide such information to the load fault module 101. Any other suitable diagnostic, informational, and/or control function(s) for the load fault module 101 is contemplated herein.

In accordance with at least one aspect of this disclosure, referring to FIG. 2, a computer implemented method 200 can include monitoring a circuit (e.g., at block 201), detecting a fault (e.g., at block 203), and determining a faulty load (e.g., at block 205) of a plurality of loads on the circuit by correlating a state of one or more loads of the plurality of loads to an effect on the circuit. The method can include successively controlling one or more controllable loads of the plurality of loads on a circuit to determine the effect of the one or more controllable loads on the circuit. Successively controlling each controllable load can include successively shutting down and/or turning on each controllable load.

Monitoring the circuit can include monitoring for elimination of the fault after shutting down and/or turning on each load to determine which controllable load caused the fault. The method can include outputting a fault indication that indicates which load is a faulty load to a user interface. In certain embodiments, monitoring a circuit can include receiving operational parameters from an advanced function circuit breaker.

In certain embodiments, the method can further include shutting down the circuit breaker and turning off all loads, turning the circuit breaker on and maintaining the circuit breaker in the on state while the faulty load is determined by iteratively powering on each load until a fault or indicator of a fault (e.g., all the parameters of the fault detection logic may not be met, but it can be determined that the operational electrical characteristics would contribute to a fault detection according to certain standards) is seen. In certain embodiments, the method can include outputting instructions to a user interface for a user to successively control one or more loads of the plurality of loads on a circuit to determine the effect of the one or more loads on the circuit. The method can include any other suitable method(s) and/or portion(s) thereof.

In accordance with at least one aspect of this disclosure, a non-transitory computer readable medium can have computer executable instructions configured to cause a computer to perform a method. The method can include monitoring a circuit, detecting a fault, and determining a faulty load of a plurality of loads on the circuit by correlating a state of one or more loads of the plurality of loads to an effect on the circuit. The method can include any other suitable method(s) and/or portion(s) thereof (e.g., as described above).

Embodiments can include systems for determining a source of a fault, e.g., arc fault, ground fault, or any other suitable fault protection. Embodiments can automatically isolate parts of the circuit to find the fault and/or can at least prompt a user on steps to perform to find the fault.

Certain embodiments include a circuit breaker that includes a load fault module as disclosed herein, e.g., as described above. Certain embodiments can include a separate load fault module from the circuit breaker (e,g., a cloud based module that all breakers and/or connected devices talk to, for example, or a locally hosted module, e.g., on a hub system).

Embodiments can self-identifying such that once fault is detected, embodiments can run the diagnostic logic to diagnose a location of the fault. In certain embodiments, the diagnosis can be manually started (e.g., through a user interface app) upon notification of fault.

Embodiments can turn a circuit breaker off and turn all connected devices off, then turn the connected devices on one at a time to isolate where the faulty device is. In certain cases, combinations of loads can operate such that the breaker and/or system sees a fault. Certain embodiment can have all the devices be all manually controlled by the user and load fault module can only output information and instructions to the user to switch devices on or off in a certain succession, and then determine the fault based on that process. Any suitable automation and/or mixture of automation/manual operation is contemplated herein.

Embodiments can include an automated branch circuit diagnostic system and partial circuit disconnect for protection. Systems can operate with certain advanced function breakers, smart switches, smart loads, and/or any other suitable device to self-diagnose cause of fault, for example. Embodiments can include logic to turn on/off loads and isolate parts of the circuit while monitoring parameters at the advanced function breaker such as voltage, current, frequency, and ground fault to determine which part of the circuit or which load is causing the issue. Embodiments can use load and fault detection analysis to make the faulty load determination.

Embodiments can report back to a user information to help solve the issue in certain embodiments. Certain embodiments can have some interaction with a user to operate non-smart devices for example.

Embodiments can include a breaker that can operate smart devices versus tripping to remove or disconnect loads or portions of circuits where it determines the fault lies. Embodiments can be used in conjunction with alarming. Embodiments can open parts of circuit or a controllable circuit breaker prior to actually being required to trip by standards. This can allow more latitude in turning back on the circuit before or after diagnostics, e.g., if algorithm intelligence determines it acceptable.

Embodiments can diagnose and narrow down automatically where in the circuit a fault may be happening. Embodiments can helps solve a current issue in the field with unwanted tripping and the difficulty in finding the faults or conditions within the system that are causing the problem. Embodiments can helps facilitate acceptance of advance function breakers and their safety benefits. Embodiments can provide coordinated communication between smart devices in the distribution system, central or distributed processing of signals available in the distribution system, and/or coordinated control of smart and connected devices within the distribution system.

Embodiments can include one or more modules having logic/machine learning techniques and software that receives information from the system, determine appropriate actions through logic and analytics, and act on the system to determine location of fault and or isolate the faulty portion of the circuit. Any other suitable components of the system are contemplated herein.

Embodiments can include any suitable computer hardware and/or software module(s) to perform any suitable function (e.g., as disclosed herein).

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. An electrical power system, comprising:
a load fault module configured to determine a faulty load of a plurality of loads on an electrical circuit by using load information and/or load power data to output a faulty load indication and/or load control.

2. The system of claim 1, wherein the load fault module is configured to be in operative communication with a circuit breaker, and to receive a fault indication from the circuit breaker to initiate determination of the faulty load.

3. The system of claim 2, wherein the load fault module is configured to be in operative communication with one or more controllable loads of the plurality of loads to control the one or more controllable loads of the plurality of loads to determine the faulty load.

4. The system of claim 3, wherein the load fault module is configured to successively shut down and/or turn on each controllable load while maintaining power from the circuit breaker to monitor whether a fault is eliminated after each shut down and/or turn on to isolate the faulty load in the plurality of loads.

5. The system of claim 4, wherein the load fault module is configured such that if the fault is eliminated after shut down and/or seen after turn on of a controllable load, that controllable load is determined to be the faulty load or associated in a branch of the circuit with the faulty load.

6. The system of claim 3, wherein the load fault module is configured to use machine learning to diagnose the plurality of loads to determine the faulty load.

7. The system of claim 2, wherein the load fault module is configured to output load power cycle instructions to a user interface module for a user to manually power off and/or power on one or more loads of the plurality of loads while maintaining power from the circuit breaker to monitor whether a fault is eliminated after each shut down and/or turn on to isolate the faulty load in the plurality of loads.

8. The system of claim 1, further comprising a circuit breaker configured to connect to the electrical circuit to selectively connect and disconnect power supply to the electrical circuit, wherein the circuit breaker is an advanced function breaker configured to output parameters of operation.

9. The system of claim 8, wherein the circuit breaker is a wireless circuit breaker configured to be remotely controlled.

10. The system of claim 9, wherein the load fault module is included in the circuit breaker.

11. The system of claim 10, wherein the circuit breaker is configured to communicate with a hub system, wherein the hub system is configured to communicate with a user device to allow control of the circuit breaker.

12. A computer implemented method, comprising:
monitoring a circuit;
detecting a fault; and
determining a faulty load of a plurality of loads on the circuit by correlating a state of one or more loads of the plurality of loads to an effect on the circuit.

13. The method of claim 12, further comprising successively controlling one or more controllable loads of the plurality of loads on a circuit to determine the effect of the one or more controllable loads on the circuit.

14. The method of claim 13, wherein successively controlling each controllable load includes successively shutting down and/or turning on each controllable load.

15. The method of claim 14, wherein monitoring the circuit includes monitoring for elimination of the fault after shutting down and/or turning on each load to determine which controllable load caused the fault.

16. The method of claim 15, further comprising outputting a fault indication that indicates which load is a faulty load to a user interface.

17. The method of claim 12, wherein monitoring a circuit includes receiving operational parameters from an advanced function circuit breaker.

18. The method of claim 17, further comprising shutting down the circuit breaker and turning off all loads, turning the circuit breaker on and maintaining the circuit breaker in the on state while the faulty load is determined by iteratively powering on each load until a fault or indicator of a fault is seen.

19. The method of claim 12, further comprising outputting instructions to a user interface for a user to successively control one or more loads of the plurality of loads on a circuit to determine the effect of the one or more loads on the circuit.

20. A non-transitory computer readable medium having computer executable instructions configured to cause a computer to perform a method, the method comprising:
monitoring a circuit;
detecting a fault; and
determining a faulty load of a plurality of loads on the circuit by correlating a state of one or more loads of the plurality of loads to an effect on the circuit.
